(19) United States
(12) Patent Application Publication
(10) Pub. No.: US 2009/0186726 A1
(43) Pub. Date: Jul. 23, 2009

(54) BELTED ALTERNATOR STARTER ACCESSORY DRIVE TENSIONING SYSTEM

(75) Inventor: Keith D. Van Maanen, Birmingham, MI (US)

Correspondence Address: Harness Dickey & Pierce, P.L.C., P.O. Box 828, Bloomfield Hills, MI, 48303, US

(73) Assignee: GM GLOBAL TECHNOLOGY OPERATIONS, INC., Detroit, MI (US)

(21) Appl. No.: 12/113,420

(22) Filed: May 1, 2008

Related U.S. Application Data
(60) Provisional application No. 61/022,660, filed on Jan. 22, 2008.

(51) Int. Cl. F16H 7/08

(52) U.S. Cl. 474/110

(57) ABSTRACT

An accessory drive tensioning system for a belt coupled to an engine may include a first tensioner, a second tensioner, and a tensioner body. The first and second tensioners may be engaged with the belt. The tensioner body may have a first piston and a second piston that bias the first and second tensioners toward the belt.

### CROSS-REFERENCE TO RELATED APPLICATIONS

This application claims the benefit of U.S. Provisional Application No. 61/022,660, filed on Jan. 22, 2008. The disclosure of the above application is incorporated herein by reference.

### FIELD

The present disclosure relates to engine accessory drive systems, and more specifically to accessory drive tensioning systems.

### BACKGROUND

The statements in this section merely provide background information related to the present disclosure and may not constitute prior art.

A mild hybrid system may shut off an engine at idle to improve fuel economy and use a motor generator unit (MGU) to restart the engine quickly. In addition, the mild hybrid system may combine regenerative braking and optimized charging with an energy storage system to further enhance fuel economy while maintaining all vehicle accessories and passenger comfort systems during the periods when the engine is temporarily shut off. A mild hybrid system may be used to provide an electric motor boost during acceleration when needed. A mild hybrid system may include an engine accessory drive to transfer motoring and generating torque between the MGU and the engine. In contrast, a full hybrid system provides direct MGU power and may achieve additional fuel savings through the use of a smaller, lighter, more efficient internal combustion engine. A mild hybrid system may provide some of the benefits of hybrid technologies without the additional cost and weight of a parallel hybrid driveline.

Typically, engine accessory drives include a drive belt wrapped around an engine crank pulley, an alternator or MGU pulley, and one or more accessory pulleys, as well as a tensioner. A minimum level of drive belt traction is required to enable torque transfer between the crank pulley, the MGU pulley, and any accessory pulleys. Belt traction is determined by belt wrap and belt tension. Belt wrap is maximized within the packaging constraints such that excessive belt tension is not required to prevent slip. Belt tension is optimized to maximize belt life while preventing slip and vibration that may reduce belt traction and generate noise. A tensioner typically includes a tensioning arm pivotally mounted at one end with a tensioning pulley attached to the opposite end that is spring loaded against the non-load bearing portion of the belt.

In a Belted Alternator Starter (BAS) mild hybrid system, the load bearing and non-load bearing portions of the belt alternate depending on whether the system is operating in a motoring mode or a generating mode. Thus, engine accessory drives used in systems of this type may employ a dual arm tensioner. In the dual arm tensioner, two arms independently pivot about a rotation axis and each arm includes a tensioning pulley at one end that is biased against either the load bearing or non-load bearing portion of the belt. While dual arm tensioners provide belt tension in the non-load bearing portion of the belt in both motoring mode and generating mode, they are limited in their ability to react to transient belt loads and lack any mechanism for damping fluctuations in the belt tension. Further, dual arm tensioners may not accommodate multiple engine accessory drive layouts.

### SUMMARY

An accessory drive tensioning system for a belt coupled to an engine may include a first tensioner, a second tensioner, and a tensioner body. The first and second tensioners may be engaged with the belt. The tensioner body may have a first piston and a second piston that bias the first and second tensioners toward the belt.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a functional block diagram of a partial powertrain for a hybrid vehicle having a belt alternator system incorporating the principles of the present disclosure.

FIG. 2 is a schematic illustration of the engine accessory drive of FIG. 1 having a tensioning system incorporating the principles of the present disclosure.

FIG. 3 is a schematic illustration of the engine accessory drive of FIG. 1 having an alternate tensioning system incorporating the principles of the present disclosure.

FIG. 4 is a flowchart illustrating exemplary steps in a method for operating an accessory drive tensioning system of the present invention.

### DETAILED DESCRIPTION

The following description is merely exemplary in nature and is not intended to limit the present disclosure, application, or uses. As used herein, the term module, circuit and/or device refers to an Application Specific Integrated Circuit (ASIC), an electronic circuit, a processor (shared, dedicated, or group) and memory that execute one or more software or firmware programs, a combinational logic circuit, and/or other suitable components that provide the described functionality.

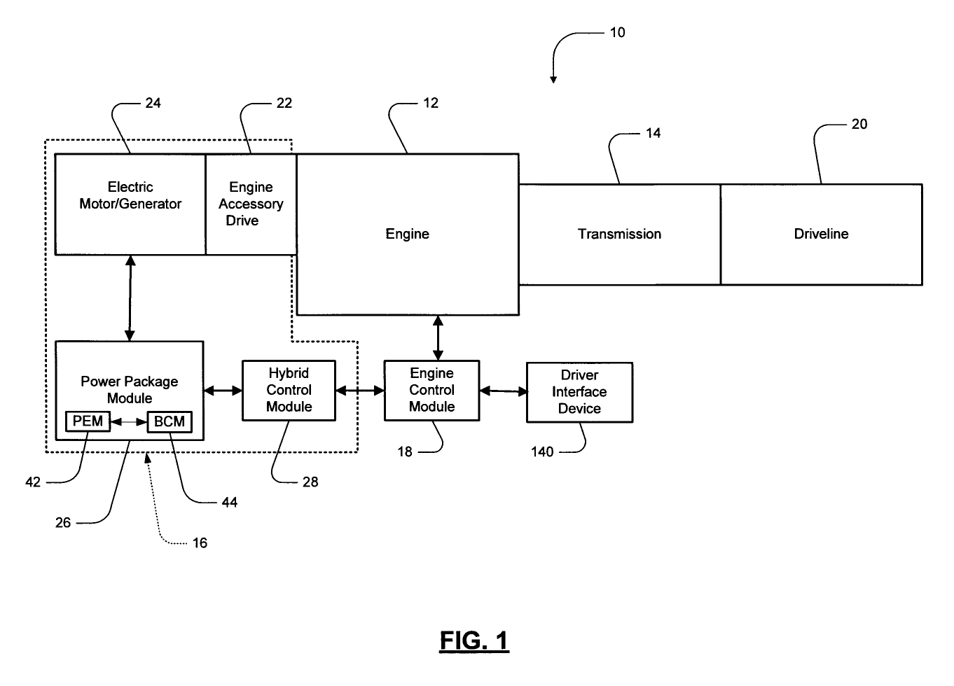

Referring to FIG. 1, a vehicle 10 includes an engine 12, an automatic transmission 14, a belt alternator starter (BAS) system 16, and an engine control module (ECM) 18. The engine 12 produces driving torque that is transferred through the transmission 14, at varying gear ratios, to a driveline 20 to drive at least one pair of wheels (not shown). The BAS system 16 improves the fuel economy of the vehicle 10 by shutting off the engine 12 at idle, providing for a quick restart of the engine 12, and optimizing battery charging under certain conditions. The BAS system 16 may include an engine accessory drive 22, a motor generator unit (MGU) 24, a power package module 26, and a hybrid control module 28.

The BAS system 16 operates in either a motoring mode or a generating mode. In generating mode, the engine accessory drive 22 transfers motoring torque from the engine 12 to the MGU 24. In motoring mode, the engine accessory drive 22 transfers torque from the MGU 24 to the engine 12. The MGU 24 supplies an electrical charge to the power package module 26 while being driven by the engine 12. The MGU 24 provides drive torque to the engine 12 while receiving electrical power from the power package module 26. The hybrid control module 28 controls the operation of the BAS system 16. Based on the input signals it receives from the ECM 18, the hybrid control module 28 generates a control signal to the power package module 26 that commands the BAS system 16 to operate in either a motoring mode or a generating mode. The engine accessory drive 22 includes a drive belt that couples the engine 12 and the MGU 24, as discussed below. The engine accessory drive 22 also includes a tensioning system that incorporates the principles of the present disclosure to maintain belt tension, provide damping for transient belt loads, and accommodate various engine accessory drive configurations.

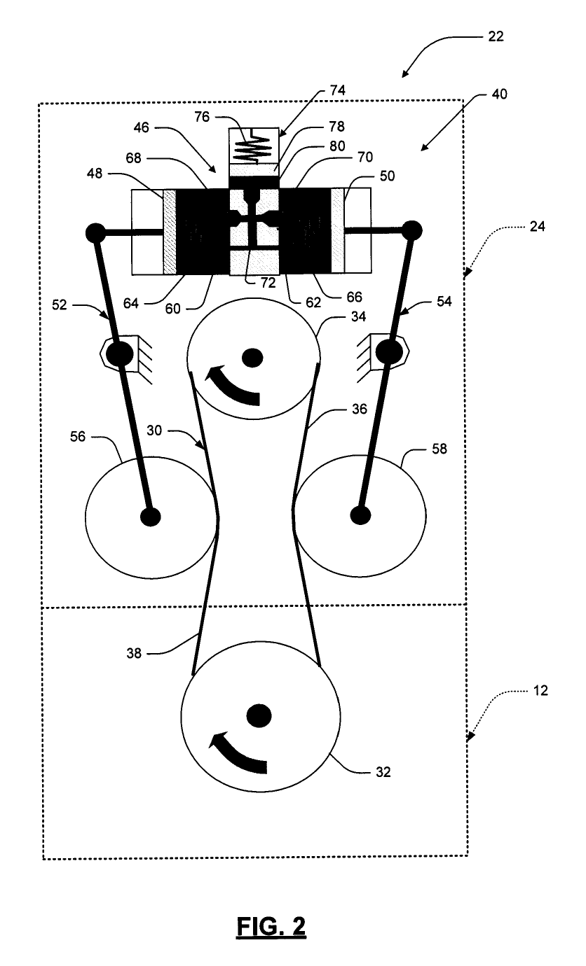

Referring to FIG. 2, a schematic illustration of the engine accessory drive 22 of FIG. 1 having a tensioning system incorporating the principles of the present disclosure is shown. The engine accessory drive 22 includes a drive belt 30 that drivingly connects a crank pulley 32, attached to the engine 12, to a MGU pulley 34, attached to the MGU 24. The drive belt 30 wraps around the crank pulley 32 and the MGU pulley 34 and extends between them in a crank span 36 from the MGU pulley 34 to the crank pulley 32 and a MGU span 38 from the crank pulley 32 to the MGU pulley 34.

As described above with respect to FIG. 1, the BAS system 16 operates in either a motoring mode or a generating mode. In generating mode, the engine accessory drive 22 transfers motoring torque from the crank pulley 32 to the MGU pulley 34. In motoring mode, the engine accessory drive 22 transfers torque from the MGU pulley 34 to the crank pulley 32. Thus, while the BAS system 16 is in generating mode, the crank span 36 experiences relatively high belt tension loads while the MGU span 38 experiences relatively low belt tension loads. Conversely, while the BAS system 16 is in motoring mode, the MGU span 38 experiences relatively high belt tension loads while the crank span 36 experiences relatively low belt tension loads.

The engine accessory drive 22 also includes a tensioning system 40 that maintains an optimum belt wrap around the crank pulley 32 and the MGU pulley 34 and an optimum belt tension in the crank span 36 and the MGU span 38, regardless of whether the BAS system 16 is in motoring mode or generating mode. The tensioning system 40 primarily consists of a tensioner body 46 having pistons 48, 50 that act independently through tensioners 52, 54 having pulleys 56, 58 to tension the drive belt 30 on both sides of the MGU pulley 34. The tensioner body 46 includes fluid cavities 60, 62 containing pressurized fluid that acts in conjunction with mechanical springs 64, 66 on pistons 48, 50 to bias tensioners 52, 54. Tensioners 52, 54 are pivotally mounted to the MGU 24 and the tensioner body 46 is fixed relative to the MGU 24 such that linear translation of pistons 48, 50 cause rotational movement of tensioners 52, 54. Fluid cavities 60, 62 are in fluid communication with each other to couple the movement of tensioners 52, 54. Ball check valves 68, 70 individually lock tensioners 52, 54, respectively, to limit the travel of each tensioner and maintain a desired belt tension on each side of the MGU pulley 34. Ball check valves 68, 70 individually lock tensioners 52, 54 by preventing fluid from escaping fluid cavities 60, 62 when the belt tension loads experienced in the crank span 36 and the MGU span 38, respectively, exceed a predetermined value.

The tensioning system 40 also includes an orifice 72 that is in fluid communication with fluid cavities 60, 62 and a shared fluid accumulator 74 that provides damping for tension loads in the drive belt 30. The fluid accumulator 74 includes a mechanical spring 76 that acts on a piston 78 to pressurize the fluid in an accumulator cavity 80 and to release ball check valves 68, 70 when the tension load in the drive belt 30 is steady or decreasing.

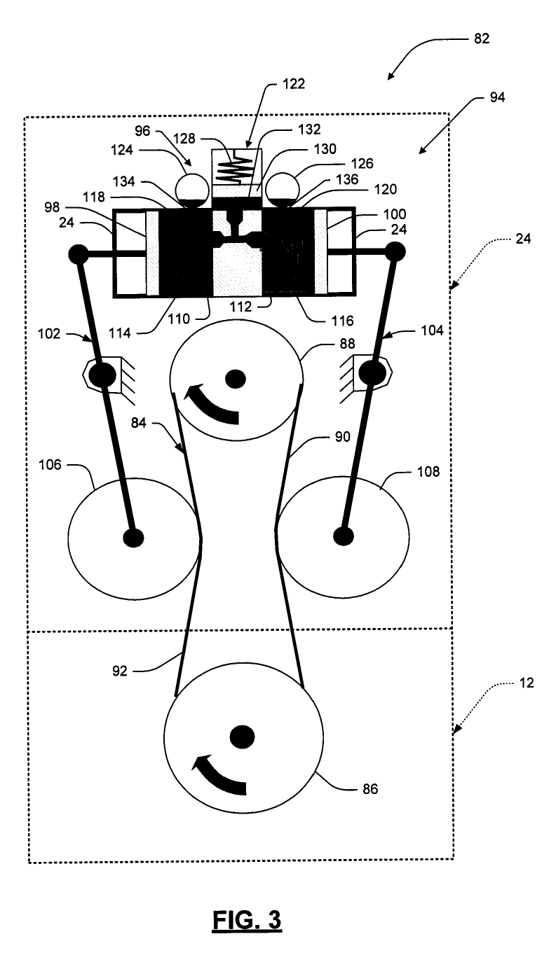

Referring to FIG. 3, a schematic illustration of the engine accessory drive of FIG. 1 having an alternate tensioning system incorporating the principles of the present disclosure is shown. An engine accessory drive 82 includes a drive belt 84 that drivingly connects a crank pulley 86, attached to the engine 12, to an MGU pulley 88, attached to the MGU 24. The drive belt 84 wraps around the crank pulley 86 and the MGU pulley 88 and extends between them in a crank span 90 from the MGU pulley 88 to the crank pulley 86 and a MGU span 92 from the crank pulley 86 to the MGU pulley 88.

As described above with respect to FIG. 1, the BAS system 16 operates in either a motoring mode or a generating mode. In generating mode, the engine accessory drive 82 transfers motoring torque from the crank pulley 86 to the MGU pulley 88. In motoring mode, the engine accessory drive 82 transfers torque from the MGU pulley 88 to the crank pulley 86. Thus, while the BAS system 16 is in generating mode, the crank span 90 experiences relatively high belt tension loads while the MGU span 92 experiences relatively low belt tension loads. Likewise, while the BAS system 16 is in motoring mode, the MGU span 92 experiences relatively high belt tension loads while the crank span 90 experiences relatively low belt tension loads.

The engine accessory drive 82 includes a tensioning system 94 that maintains the optimum belt wrap around the crank pulley 86 and the MGU pulley 88 and optimum belt tension in the crank span 90 and the MGU span 92, regardless of whether the BAS system 16 is in motoring mode or generating mode. The tensioning system 94 primarily consists of a tensioner body 96 having pistons 98, 100 that act independently through tensioners 102, 104 having pulleys 106, 108 to tension the drive belt 84 on both sides of the MGU pulley 88. The tensioner body 96 includes fluid cavities 110, 112 containing pressurized fluid that acts in conjunction with mechanical springs 114, 116 on pistons 98, 100 to bias tensioners 102, 104. Tensioners 102, 104 are pivotally mounted to the MGU 24 and the tensioner body 96 is fixed relative to the MGU 24 such that linear translation of pistons 98, 100 cause rotational movement of tensioners 102, 104. Fluid cavities 110, 112 are in fluid communication with each other to couple the movement of tensioners 102, 104. Ball check valves 118, 120 individually lock tensioners 102, 104, respectively, to limit the travel of each tensioner and maintain a desired belt tension on each side of the MGU pulley 88. Ball check valves 118, 120 individually lock tensioners 102, 104 by preventing fluid from escaping fluid cavities 110, 112 when the belt tension loads experienced in the crank span 90 and the MGU span 92, respectively, exceed a predetermined value.

The tensioning system 94 includes a shared fluid accumulator 122 and separate fluid accumulators 124, 126. The fluid accumulator 122 includes a mechanical spring 128 that acts on a piston 130 to pressurize the fluid in an accumulator cavity 132 and release fluid ball check valves 118, 120 when the tension load in the drive belt 84 is steady or decreasing. Fluid accumulators 124, 126 are in fluid communication with fluid cavities 110, 112 via orifices 134, 136, respectively. Fluid accumulators 124, 126 include compressed gas separated from the fluid traveling through orifices 134, 136 by an elastic diaphragm (not shown). In contrast to the tensioning system 40 shown in FIG. 2, the tensioning system 94 does not include an orifice that allows fluid to enter the fluid accumulator 122 when high belt loads in the drive belt 84 cause ball check valves 118, 120 to engage. Thus, when ball check valves 118, 120 are engaged, fluid accumulators 124, 126 provide damping for the drive belt 84 without allowing fluid to escape fluid cavities 110, 112, thereby maintaining tensioners 102, 104 in a locked position.

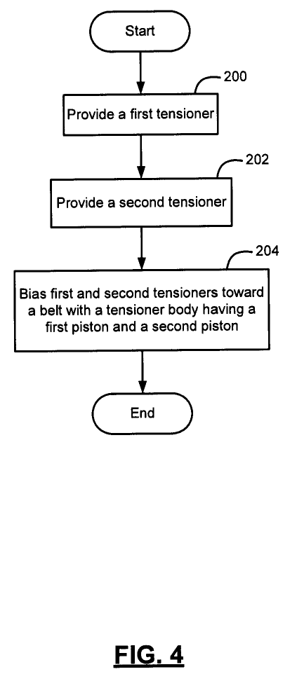

Referring to FIG. 4, exemplary steps in a method for operating an accessory drive tensioning system will be described in detail. In step 200, the method comprises providing a first tensioner engaged with a belt. In step 202, the method comprises providing a second tensioner engaged with the belt. In step 204, the method comprises biasing the first and second tensioners toward the belt with a tensioner body having a first piston and a second piston.

Each of the described tensioning systems incorporate several tuning features that improve the adaptability of the BAS system, or similar mild hybrid systems, for various vehicle applications. While the tensioner body and tensioners are depicted as being mounted to the MGU, other mounting locations are possible to satisfy packaging constraints. Belt tension may be optimized by modifying the rates of the springs acting on the pistons, the area of the pistons acting on the tensioners, and the tensioner lever arm geometry. Belt tension may also be optimized by modifying the diameter of the orifices at the ball check valves to set the belt load and rate that would cause each ball check valve to engage, thereby preventing further movement of the tensioners. Belt damping may be optimized by modifying the rate of the spring in the shared accumulator and the diameter of the orifice connecting the fluid cavities to the shared accumulator, or the pressure of the compressed gas in the separate accumulators and the diameter of the orifices connecting the fluid cavities to the individual accumulators. Moreover, belt tension and damping may be developed independently for the belt spans on either side of the MGU pulley, which enables the BAS system to individually react to different load ranges in each belt span.

What is claimed is:

1. An accessory drive tensioning system for a belt coupled to an engine, comprising:
a first tensioner engaged with said belt;
a second tensioner engaged with said belt; and
a tensioner body having a first piston and a second piston that bias said first and second tensioners toward said belt.

2. The accessory drive tensioning system of claim 1, wherein said first and second tensioners are pivotally mounted to a vehicle component and said tensioner body is fixed relative to said vehicle component such that linear translation of said first and second pistons causes rotational movement of said first and second tensioners.

3. The accessory drive tensioning system of claim 1, wherein said first piston biases said first tensioner toward said belt in a first direction and said second piston biases said second tensioner toward said belt in a second direction that is opposite to said first direction.

4. The accessory drive tensioning system of claim 1, wherein:
said belt is coupled to a motor generator unit that is driven by said belt in a first mode of operation and that drives said belt in a second mode of operation;
said first tensioner is biased against a first span of said belt from said engine to said motor generator unit; and
said second tensioner is biased against a second span of said belt from said motor generator unit to said engine.

5. The accessory drive tensioning system of claim 1, wherein said belt is coupled to at least one accessory drive component.

6. The accessory drive tensioning system of claim 1, wherein said tensioner body includes a first mechanical spring and a second mechanical spring that act on said first and second pistons to bias said first and second tensioners, respectively.

7. The accessory drive tensioning system of claim 1, wherein:
said tensioner body includes a first fluid cavity adjacent to said first piston and a second fluid cavity adjacent to said second piston;
said first fluid cavity contains pressurized fluid that acts on said first piston to bias said first tensioner; and
said second fluid cavity contains pressurized fluid that acts on said second piston to bias said second tensioner.

8. The accessory drive tensioning system of claim 7, wherein said first and second fluid cavities are in fluid communication with each other, thereby coupling the movement of said first and second tensioners.

9. The accessory drive tensioning system of claim 7, wherein said tensioner body includes a first ball check valve that is disposed in a first fluid passageway exiting said first fluid cavity and a second ball check valve that is disposed in a second fluid passageway exiting said second fluid cavity.

10. The accessory drive tensioning system of claim 9, wherein said first ball check valve prevents fluid from exiting said first fluid cavity through said first fluid passageway when a first belt load acting on said first tensioner exceeds a predetermined value.

11. The accessory drive tensioning system of claim 10, wherein preventing fluid from exiting said first fluid cavity through said first fluid passageway prevents further movement of said first tensioner and maintains tension in a first span of said belt that is adjacent to said first tensioner.

12. The accessory drive tensioning system of claim 9, wherein said second ball check valve prevents fluid from exiting said second fluid cavity through said second fluid passageway when a second belt load acting on said second tensioner exceeds a predetermined value.

13. The accessory drive tensioning system of claim 12, wherein preventing fluid from exiting said second fluid cavity through said second fluid passageway prevents further movement of said second tensioner and maintains tension in a second span of said belt that is adjacent to said second tensioner.

14. The accessory drive tensioning system of claim 7, wherein said first and second fluid cavities are in fluid communication with a shared fluid accumulator that pressurizes fluid acting on said first and second pistons, thereby damping transient belt loads acting on said first and second pistons through said first and second tensioners, respectively.

15. The accessory drive tensioning system of claim 14, wherein said shared fluid accumulator includes a third mechanical spring acting on a piston to pressurize fluid in said first and second fluid cavities.

16. The accessory drive tensioning system of claim 14, wherein said tensioner body includes an orifice between said first and second fluid cavities that is in fluid communication with said shared fluid accumulator, said orifice allowing fluid to enter said first and second fluid cavities from said shared fluid accumulator, thereby damping transient belt loads acting on said first and second pistons through said first and second tensioners, respectively.

17. The accessory drive tensioning system of claim 7, wherein:
said tensioner body includes a first fluid accumulator and a second fluid accumulator;
said first fluid accumulator is in fluid communication with said first fluid cavity through a first orifice, thereby damping transient belt loads acting on said first piston through said first tensioner; and
said second accumulator is in fluid communication with said second fluid cavity through a second orifice, thereby damping transient belt loads acting on said second piston through said second tensioner.

18. The accessory drive tensioning system of claim 17, wherein said first and second fluid accumulators each contain compressed gas in an elastic diaphragm that pressurizes fluid in said first and second fluid cavities, respectively.
